(19) United States
(12) Patent Application Publication
(10) Pub. No.: US 2023/0048710 A1
(43) Pub. Date: Feb. 16, 2023

(54) METHODS AND STRUCTURES FOR TERMINATING CABLE GROUND WIRES

(71) Applicant: Molex, LLC, Lisle, IL (US)

(72) Inventors: Gianni R. BARDELLA, Maumelle, AR (US); Ayman ISAAC, Glendale, AZ (US); Darian SCHULZ, Little Rock, AR (US); Thomas G. PREMO, Downers Grove, IL (US); Augusto PANELLA, Naperville, IL (US)

(73) Assignee: Molex, LLC, Lisle, IL (US)

(21) Appl. No.: 17/791,535

(22) PCT Filed: Jan. 14, 2021
(86) PCT No.: PCT/IB2021/050246

§ 371 Date: Jul. 8, 2022

Related U.S. Application Data
(60) Provisional application No. 62/960,711, filed on Jan. 14, 2020.

(51) Int. Cl. H01R 12/53; H01B 7/00; H01R 43/18; H01R 43/02

(52) U.S. Cl. CPC H01R 12/53; H01B 7/0045; H01R 43/18; H01R 43/0263; H01R 24/60

(57) ABSTRACT

A method for connecting a ground wire of cable comprises the steps of: receiving a ground wire of the cable, over one or more core signal conductors of the cable, in an open, connection slot or notch of a respective grounding section of a grounding structure; and restraining the ground wire so that the ground wire physically contacts a body of the respective grounding section and forms an electrical ground path with the body of the section.

### RELATED APPLICATIONS

This application claims the benefit of priority from U.S. Provisional Application No. 62/960,711 filed Jan. 14, 2020. This application incorporates the entire disclosure of the 62/960,711 Application as if it was set forth in full herein.

### FIELD OF THE INVENTION

This disclosure relates to the field of electrical cabling, more specifically to the termination of ground wires that may be part of a cable assembly.

### INTRODUCTION

This section introduces aspects that may be helpful to facilitate a better understanding of the described invention(s). Accordingly, the statements in this section are to be read in this light and are not to be understood as admissions about what is, or what is not, in the prior art.

It is a challenge to connect ground wires that are a part of data communication cables. Typically, to connect such a wire (sometimes referred to as a “drain” wire) the wire is configured to the side of a signal conductor. However, such a configuration has its drawbacks.

Accordingly, it is desirable to provide inventive methods and structures that provide solutions to the drawbacks of existing, ground wire connection configurations.

### SUMMARY

The inventors describe various exemplary methods and structures for connecting ground wires in data communication cables. One inventive method may comprise a method for connecting a ground wire of data/telecommunication cable. Such a method may comprise: receiving a ground wire of the cable, over one or more core signal conductors of the cable, in an open, connection slot or notch of a respective grounding section of a grounding structure; and frictionally restraining the ground wire so that the ground wire physically contacts a body of the respective grounding section and forms an electrical ground path with the body of the section.

In the exemplary method, the grounding structure may comprise a plurality of integral grounding sections, or alternatively, may comprise a plurality of separate grounding sections, for example.

In the exemplary method, the cable may comprise a twinax cable, for example.

Further, the exemplary method may comprise: (i) configuring the open access slot or notch to allow access to the core signal conductors; (ii) connecting the signal core conductors to a printed circuit board (PCB); and/or (iii) connecting supporting structures of the grounding section to a PCB, where each connection of a supporting structure forms a symmetrical ground path to the PCB.

Still further, the exemplary method may comprise covering the ground wire and cable with a cable overmold assembly, and/or affixing the cable overmold assembly to a main housing assembly, for example.

In addition to the features described above, an exemplary method may further comprise configuring the grounding structure with a plurality of integral grounding sections and a plurality of integral middle sections configured between each grounding section and further configured to contact a top surface of a PCB, or configuring the grounding structure with a plurality of integral grounding sections and a plurality of integral middle sections configured between each grounding section and further configured to contact a bottom surface of a PCB.

Additionally, the exemplary method may comprise configuring the grounding structure with a plurality of integral grounding sections, each section comprising a protrusion configured to make contact with a fixture during a soldering process to hold the grounding structure in place.

The inventors further provide for complimentary grounding structures. For example, one exemplary grounding structure for connecting a ground wire of a data/telecommunication cable may comprise: an open slot or notch of a grounding section of the grounding structure that receives a ground wire of the cable configured over one or more core signal conductors of the cable, and frictionally restrains the ground wire so that the ground wire physically contacts a body of the grounding section and forms an electrical ground path with the body.

Further, another grounding structure may comprise a plurality of integral grounding sections, each section comprising a respective open, connection slot or notch that receives a respective ground wire of a cable configured over one or more core signal conductors of the respective cable, and each frictionally restrains the respective ground wire so that the respective ground wire physically contacts a body of the respective grounding section and forms an electrical ground path with the respective body.

Yet another exemplary grounding structure may comprise a plurality of separate grounding sections, each section comprising a respective open, connection slot or notch that receives a respective ground wire of a cable configured over one or more core signal conductors of the respective cable, and each frictionally restrains the respective ground wire so that the respective ground wire physically contacts a body of the respective grounding section and forms an electrical ground path with the respective body.

In an embodiment, the cable connected to each of the grounding structures may comprise a twinax cable, for example.

In an embodiment an open slot or notch of an exemplary grounding section may be configured to allow access to the one or more core signal conductors.

Still further, a printed circuit board (PCB) may be connected to one or more core signal conductors of a cable connected to a grounding structure.

In embodiments, the grounding structures may comprise supporting structures that may be configured to be connected to a PCB, where each connection of a supporting structure to a PCB may form a symmetrical ground path to the PCB.

In additional embodiments, a cable overmold assembly may be configured to cover the ground wire and cable connected to a grounding structure, where the cable overmold assembly may be affixed to a main housing assembly, for example.

One or more of the grounding structures, may additionally comprise either (i) a plurality of integral middle sections configured between each grounding section of the structure, where each middle section is further configured to contact a top surface of a PCB, or, alternatively, (ii) a plurality of integral middle sections configured between each grounding section and further configured to contact a bottom surface of a PCB.

In still another embodiment, an exemplary grounding section of a grounding structure may comprise a protrusion configured to make contact with a fixture during a soldering process to hold the grounding structure in place.

Another exemplary method for connecting a ground wire of a data/telecommunication cable may comprise: receiving and holding at least one cable, comprising at least one signal conductor and at least one ground wire configured over the at least one signal conductor, in a cable organizer; receiving and holding a ground bar structure, in a substantially fixed position, in the cable organizer; and receiving and frictionally restraining the ground wire in the ground bar structure so that the ground wire is physically in contact with a body of the ground bar structure, and forms an electrical ground path with the body.

In such a method, the cable may comprise a twinax cable, for example. Further, in such a method the cable organizer may comprise an engineered plastic, such as a Liquid Crystal Polymer, for example.

In an embodiment, the cable organizer used in such a method may comprise a first part for receiving and holding the cable and a second part for receiving and holding the ground bar structure.

Still further, such an exemplary method may comprise: (i) connecting the first and second parts of the cable organizer; and/or (ii) connecting the cable organizer to a PCB.

In an embodiment, the ground bar used in such a method may comprise a conductive and solderable/weldable material (e.g., a copper alloy a plated or conductive laminate material).

In embodiments of the invention the exemplary method may still further comprise receiving the ground wire in an open connection slot or notch of the ground bar structure, where the ground bar structure may comprise an integral grounding structure, for example.

When required, the exemplary method may comprise connecting the ground bar structure to the PCB, and/or connecting supporting structures of the ground bar structure to the PCB, where each supporting structure forms a symmetrical ground path to the PCB.

In addition to the inventive methods described above and herein, the inventors provide parallel inventive assemblies and complimentary assemblies. One such assembly for connecting a ground wire of a data/telecommunication cable may comprise: a PCB; at least one cable comprising at least one signal conductor and at least one ground wire configured over the at least one signal conductor; and a connective structure mounted to the PCB and connected to the at least one ground wire that terminates on the connective structure at a termination area, where the connective structure provides at least two substantially symmetric paths from the termination area to the PCB.

Further, the connective structure of the inventive assembly may comprise at least two legs, each leg forming one of the substantially symmetrical paths.

A further description of these and additional embodiments is provided by way of the figures, notes contained in the figures and in the claim language included below. The claim language included below is incorporated herein by reference in expanded form, that is, hierarchically from broadest to narrowest, with each possible combination indicated by the multiple dependent claim references described as a unique standalone embodiment.

### BRIEF DESCRIPTION OF THE DRAWINGS

The present invention is illustrated by way of example and not limited in the accompanying figures in which like reference numerals indicate similar elements and in which:

FIGS. 1A to 1E depict different views of an exemplary method and structure according to an embodiment of the invention.

FIGS. 2A to 2D depict different views of another exemplary method and structure according to an embodiment of the invention.

FIGS. 3A to 3F depict different views of yet another exemplary method and structure according to an embodiment of the invention.

Specific embodiments of the present invention are disclosed below with reference to various figures and sketches. Both the description and the illustrations have been drafted with the intent to enhance understanding. For example, the dimensions of some of the elements in the figures may be exaggerated relative to other elements, and well-known elements that are beneficial or even necessary to a commercially successful implementation may not be depicted so that a less obstructed and a more clear presentation of embodiments may be achieved. Further, dimensions and other parameters described herein are merely exemplary and non-limiting.

### DETAILED DESCRIPTION

Simplicity and clarity in both illustration and description are sought to effectively enable a person of skill in the art to make, use, and best practice the present invention in view of what is already known in the art. One skilled in the art will appreciate that various modifications and changes may be made to the specific embodiments described herein without departing from the spirit and scope of the present invention. Thus, the specification and drawings are to be regarded as illustrative and exemplary rather than restrictive or all-encompassing, and all such modifications to the specific embodiments described herein are intended to be included within the scope of the present invention. Yet further, it should be understood that the detailed description that follows describes exemplary embodiments and is not intended to be limited to the expressly disclosed combination(s). Therefore, unless otherwise noted, features disclosed herein may be combined together to form additional combinations that were not otherwise described or shown for purposes of brevity.

Relatedly, to the extent that any of the figures or text included herein depicts or describes dimensions or operating parameters it should be understood that such information is merely exemplary and is provided to enable one skilled in the art to make and use an exemplary embodiment of the invention without departing from the scope of the invention.

As used herein and in the appended claims, the terms “comprises,” “comprising” or any other variation thereof is intended to refer to a non-exclusive inclusion, such that a process, method, article of manufacture, device or apparatus (e.g., a connector) that comprises a list of elements does not include only those elements in the list, but may include other elements not expressly listed or inherent to such process, method, article of manufacture, device or apparatus. The terms “a” or “an”, as used herein, are defined as one, or more than one. The term “plurality”, as used herein, is defined as two, or more than two. The term “another”, as used herein, is defined as at least a second or more. Unless otherwise indicated herein, the use of relational terms, if any, such as “first” and “second”, “top”, “bottom”, and the like are used solely to distinguish one entity or action from another entity or action without necessarily requiring or implying any actual such relationship, priority, importance or order between such entities or actions.

The use of “or” or “and/or” herein is defined to be inclusive (A, B or C means any one or any two or all three letters) and not exclusive (unless explicitly indicated to be exclusive); thus, the use of “and/or” in some instances is not to be interpreted to imply that the use of “or” somewhere else means that use of “or” is exclusive.

The terms “includes”, “including” and/or “having”, as used herein, are defined as comprising (i.e., open language).

It should also be noted that one or more exemplary embodiments may be described as a method. Although a method may be described in an exemplary sequence (i.e., sequential), it should be understood that such a method may also be performed in parallel, concurrently or simultaneously. In addition, the order of each formative step within a method may be re-arranged. A described method may be terminated when completed, and may also include additional steps that are not described herein if, for example, such steps are known by those skilled in the art.

As used herein, the term “embodiment” or “exemplary” mean an example that falls within the scope of the invention(s).

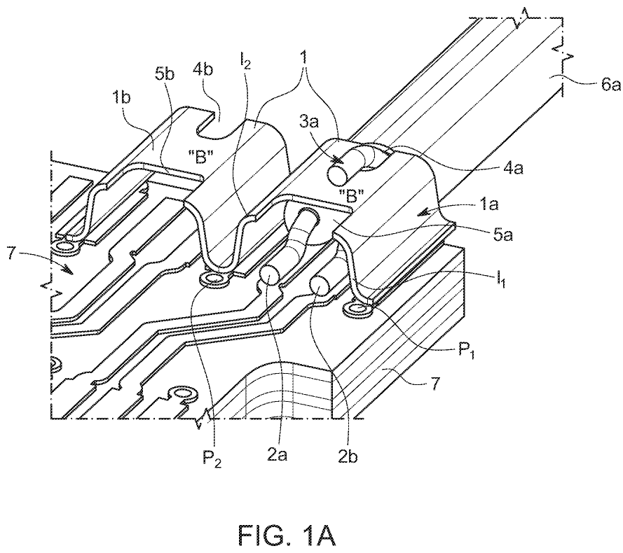

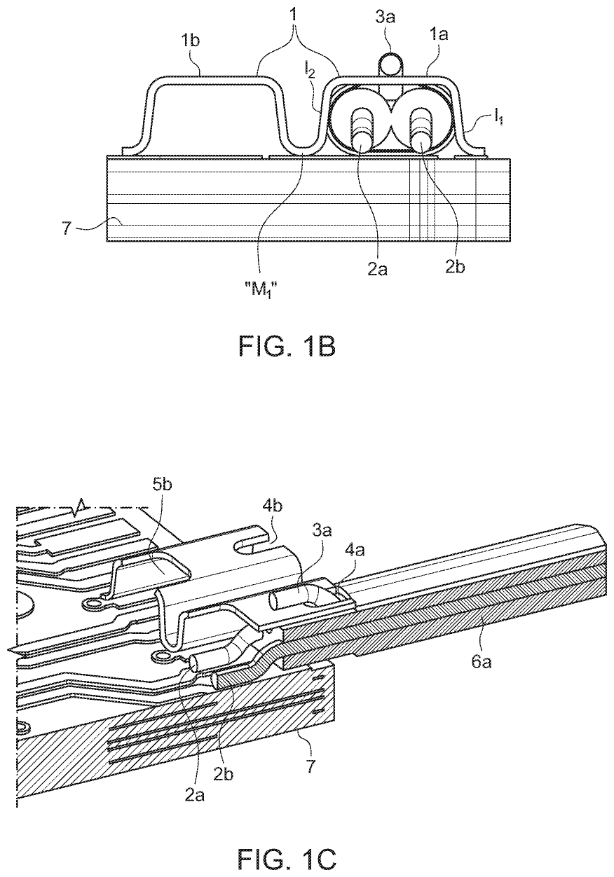

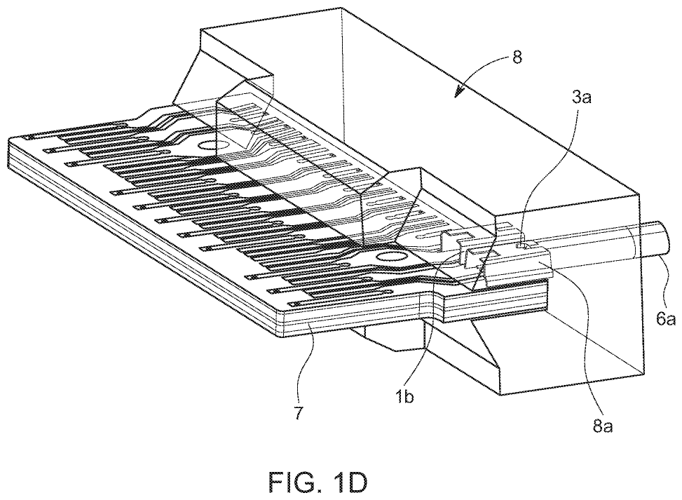

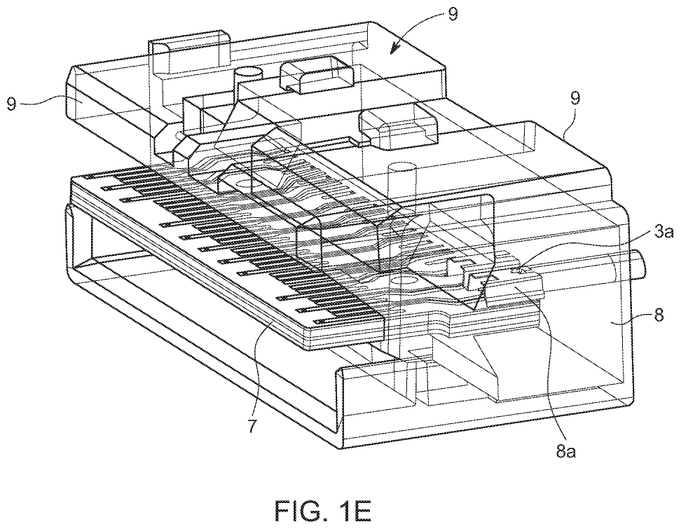

Referring now to FIGS. 1A to 1E there is depicted one exemplary embodiment of an inventive connection method and related grounding structure 1 for connecting a ground wire 3a that is part of an inventive data/telecommunication cable 6a In an embodiment, the cable 6a may comprise a twinax cable, for example.

Cable 6a may comprise one or more core signal conductors 2a, 2n (where “n” indicates a last conductor; only two 2a, 2b are shown in FIG. 1A), insulation and one or more layers of an outer layers (e.g., a jacket, not labeled in figures). In the embodiment depicted in FIG. 1A the inventive cable 6a comprises two core signal conductors 2a, 2b (e.g., copper conductors) though it should be understood that this is merely exemplary. Alternatively, the cable 6a may comprise a single core signal conductor or may comprise more than two core signal conductors.

In this embodiment, the inventive grounding structure 1 may be configured to comprise one or more integral grounding sections 1a, 1n (where “n” indicates a last grounding section; only two 1a, 1b are shown in FIG. 1A), where each integral section 1a to 1n may be configured to securely, physically hold and electrically ground at least one ground wire 3a to 3n (only one 3a is shown in FIG. 1A), for example, over one or more respective conductors 2a, 2n. Though the embodiment in FIG. 1A (and FIGS. 1B to 1E) depicts the grounding sections 1a, 1b as being a part of an integral grounding structure, it should be understood that one or more of the sections may be individual grounding sections, for example. Said another way, the ground structure 1 may comprises a plurality of integral grounding sections 1a to 1n, or, alternatively, may comprise a plurality of separate grounding sections 1a to 1n. Further, the grounding structure 1 may be a stamped, grounding structure, for example. As shown the structure 1 is an integral structure 1 that comprises integral connecting, middle structures M₁, for example, configured between each section 1a to 1n of the structure 1 and further configured to contact a surface of the PCB 7. Accordingly, in one embodiment, the grounding structure 1 may be configured to comprise a plurality of integral grounding sections 1a to 1n and a plurality of integral middle sections M₁, where each middle section may be configured between respective, adjacent grounding sections 1a and 1n, for example, and further configured to contact a top surface of a PCB.

Each of the integral sections 1a, in may be configured to include an open connection slot or notch 4a to 4n (only two 4a, 4b are shown in FIG. 1A), respectively, and an open access slot or notch 5a to 5n (only two 5a, 5b are shown in FIG. 1A), respectively. As configured, the ground wire 3a is not configured on a side of the conductors 2a, 2b which reduces the “footprint” of the cable 6a connections (width-wise). In addition the inventors believe that configuring the ground wire 3a over the respective conductors 2a, 2b (i.e., not on a side) and separated by the structure 1 reduces the chances that the ground wire 3a will make contact with the conductors 2a, 2b and cause an electrical short as well substantially eliminating the formation of an unsymmetrical grounding structure (i.e., the ground path is biased to one side of the conductors).

In an embodiment, each of the open connection slots or notches 4a, 4b (up to 4n) may be configured to receive a ground wire (e.g., ground wire 3a) over one or more conductors 2a, 2b the cable and frictionally restrain the ground wire so that the ground wire is physically in contact with the body “B” of a respective section 1a, 1b, respectively, and forms an electrical ground path with the B body as well. The ground path allows unwanted signals to flow to an electrical ground and thereby protect cables 6a to 6n (only one 6a is shown in FIG. 1A) and minimize the effect of such unwanted signals on desirable signals flowing within conductors 2a, 2b of a respective cable 6a. Further, because the respective sections 1a, 1b cover and restrain their respective round wire from moving, the inventors believe the configuration described herein may reduce the effects of electrical crosstalk between respective, adjacent cables (i.e., cables 6a, 6b; though cable 6b is not shown it would typically be connected). Yet further, the ground wire 3a may be additionally soldered, for example, to the section 1a to name just one of many types of methods that may be used to connect the ground wire 3a to the section 1a.

Further, each of the open access slots or notches 5a, 5b may be configured to allow access to its respective core signal conductors 2a, 2b so that the conductors 2a, 2b can be connected (e.g., soldered) to a printed circuit board (PCB) 7 (e.g., paddle card), or to another cable, electronic device or connector, for example, and/or to allow repair or visual inspection of the conductors 2a, 2b.

FIGS. 1B and 1C depict different views of the exemplary method and structure shown in FIG. 1A. In FIG. 1B a cross-sectional view of the structure 1 is depicted while in FIG. 1C the outer portions of the cable 6a and end of the grounding section 1a have been shown as transparent in order to allow the reader to view the conductor 2b within cable 6a.

In embodiments, the conductors 2a, 2b may be connected (e.g., soldered) to the PCB 7. Further, supporting structures or legs l₁ and l₂ of each section 1a to 1n of the structure 1 may connect (e.g., soldered) each section 1a to 1n of the structure 1 to the PCB 7 at points P₁ and P₂, for example. In embodiments, as connected, each supporting structure or leg l₁ and l₂ of each section 1a to 1n may form a symmetrical ground path, each path including the structure that leads from a termination area (i.e., the position on the section 1a to 1n where the ground wire is connected to the section) to the PCB 7.

In FIG. 1D, the ground wire 3a and cable 6a are shown as covered by to a cable overmold assembly 8, it being understood that the ground wire 3a is connected to the PCB 7 using the inventive method and inventive structure 1 described elsewhere herein. As shown in FIG. 1D, the inventive structure 1 may be protected by an overmold end section 8a.

In FIG. 1E, the ground wire 3a and cable 6a are shown as covered by a cable overmold assembly 8 that in turn may be mechanically affixed to a main housing assembly 9, it being understood that the ground wire 3a is connected to the PCB 7 using the inventive method and inventive structures described elsewhere herein.

In more detail, in one embodiment after the cable conductors and are soldered to the PCB 7, the ground wire 3a is connected (e.g., soldered) to the structure 1, and the structure 1 is connected (e.g., soldered) to the PCB 7 (collectively referred to as a “sub-assembly”), the sub-assembly may be covered (via molding or potting for example) with an encapsulant that may be an insulating dielectric (e.g., a hotmelt material, such as a resin-based material). The encapsulant forms the overmolding structure 8. Accordingly, the structure 1 and ground wire 3a may be encapsulated within the overmolding structure 8, for example.

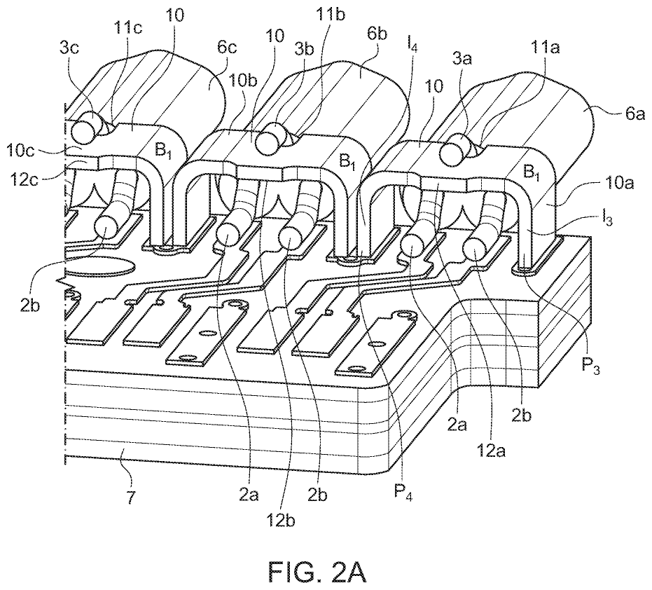

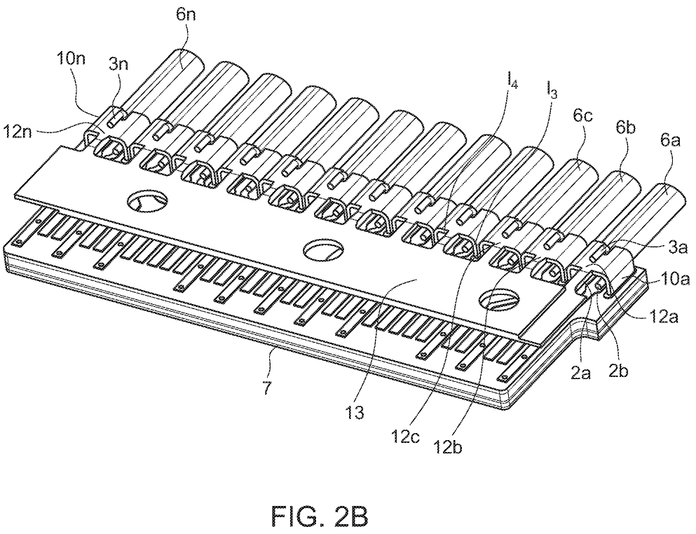

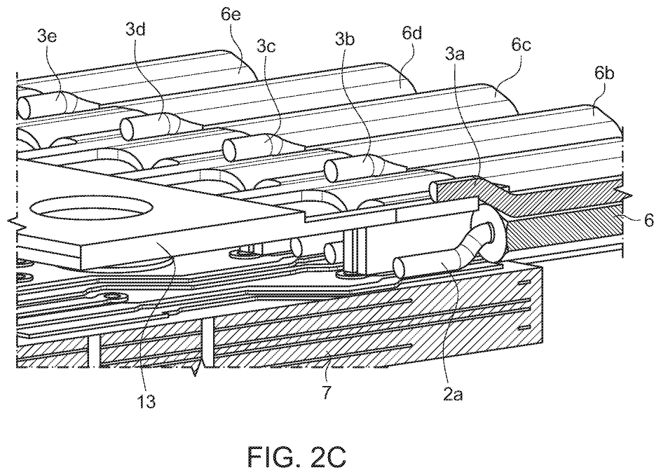

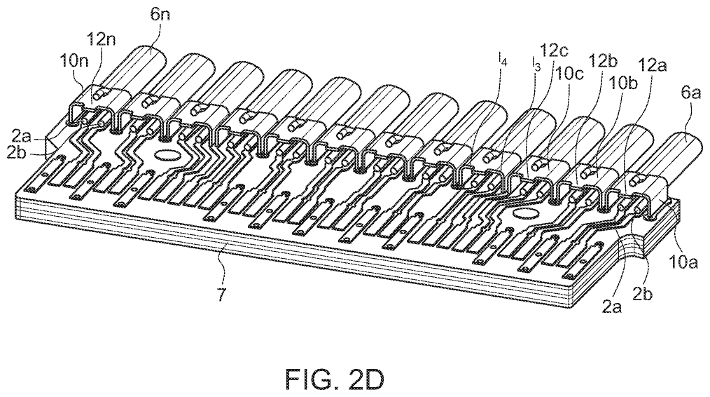

Referring now to FIGS. 2A to 2D there is depicted another exemplary embodiment of an inventive connection method and related grounding structure 10 for connecting a ground wire 3a that is part of an inventive cable 6a In an embodiment, the cable 6a may comprise a twinax cable, for example.

Similar to before, cable 6a may comprise one or more core signal conductors 2a, 2n (only two 2a, 2b are shown per cable 6a, 6b, 6c in FIG. 2A; where “n” indicates a last conductor), insulation and one or more outer layers (e.g., a jacket; not labeled in figures). In the embodiment depicted in FIG. 2A each inventive cable 6a to 6c comprises two core signal conductors 2a, 2b (e.g., copper conductors) though it should be understood that this is merely exemplary. Alternatively, the cables 6a to 6c may comprise a single core signal conductor or may comprise more than two core signal conductors.

In this embodiment, the inventive grounding structure 10 may be configured to comprise one or more grounding sections 10a, 10n (only three sections 10a to 10c are shown in FIG. 2A, where “n” indicates a last grounding section), where each section 10a to 10n may be configured to securely, physically hold and electrically ground at least one respective ground wire 3a, 3b, 3c for example, over respective conductors 2a, 2b. Each of the sections 10a to 10c (up until “n” sections) may be configured to include an open connection slot or notch 11a to 11n (only three 11a to 11c are shown in FIG. 2A), respectively, and a protrusion 12a to 12n (only three protrusions 12a to 12c are shown in FIG. 2A, where “n” indicates a last protrusion), respectively. As configured, the ground wires 3a to 3c are not configured on a side of the respective conductors 2a, 2b which reduces the “footprint” of the cables 6a to 6c connections (width-wise). In addition the inventors believe that configuring the ground wires 3a to 3c over the respective conductors 2a, 2b and separated by the sections 10a to 10c reduces the chances that the ground wires 3a to 3c will make contact with their respective conductors 2a, 2b and cause an electrical short as well substantially eliminating the formation of an unsymmetrical grounding structure.

In embodiments, the grounding sections 10a to 10n may be configured as individual sections or one or more of the sections 10a to 10n may be combined into an integral ground structure, for example. In more detail, when the sections 10a to 10n comprise discrete, individual grounding sections each section may be connected to an individual pad (not shown in figures). Alternatively, the one or more grounding sections 10a to 10n may be made a part of an integral structure that is connected (e.g., soldered) to a common grounding structure (not shown). When configured as an integral structure, the structure 10 may comprise integral connecting, middle structures, for example, configured between each section 10a to 10n of the structure 10 and further configured to contact a bottom surface of the PCB 7 (not shown). Accordingly, in one embodiment, the grounding structure 10 may be configured to comprise a plurality of integral grounding sections 10a to 10n and a plurality of integral middle sections where each middle section may be configured between respective, adjacent grounding sections 10a and 10n, for example, and further configured to contact a bottom surface of a PCB (a surface on a side opposite the side that the middle sections M₁ make contact with in FIG. 1B).

If desired, a middle section of a particular embodiment herein may be connected (e.g., soldered) to a surface of a PCB, for example.

In an embodiment, each of the open connection slots or notches 11a to 11c may be configured to receive a ground wire 3a to 3c and frictionally restrain the ground wire so that the ground wire is physically in contact with the body “B₁” of a respective section 10a to 10c, respectively, and forms an electrical ground path with the B₁ body as well. The ground path allows unwanted signals to flow to an electrical ground and thereby protect cables 6a to 6c and minimize the effect of such unwanted signals on desirable signals flowing within conductors 2a, 2b of each cable 6a to 6c. Further, because the sections 10a to 10c cover and restrain the respective ground wires 3a to 3c from moving, the inventors believe the configuration described herein may reduce the effects of electrical crosstalk between respective cables 6a to 6c.

Further, each of the bodies B₁ may be configured on one edge to allow access to the core signal conductors 2a, 2b so that the conductors 2a, 2b can be connected (e.g., soldered) to a printed circuit board (PCB) 7 (e.g., paddle card), or to another cable, electronic device or connector, for example, and/or to allow repair or visual inspection of the conductors 2a, 2b.

Similar to before, in embodiments a ground wire 3a may be additionally soldered, for example, to a section 10a to name just one of many types of methods that may be used to connect the ground wire 3a to the section 10a. Further, the conductors 2a, 2b may be connected (e.g., soldered) to the PCB 7. Further, supporting structures or legs l₃ and l₄ of each section 10a to 10n of the structure 10 may connect (e.g., via soldering) each section 10a to 10n to the PCB 7. In embodiments, each supporting structure or leg l₃ and l₄ of each section 10a to 10n may form a symmetrical ground path, each path including the structure that leads from a termination area (i.e., the position on the section 10a to 10n where the ground wire is connected to the section) to the PCB 7.

FIGS. 2B to 2D depict views of the exemplary method and grounding sections 10a to 10n shown in FIG. 2A during (FIGS. 2B, 2C) and after (FIGS. 2 2D) the process of connecting the grounding sections 10a to 10c to the PCB 7 using a connection process (e.g., soldering process).

In an embodiment, to solder each of the elements 10a to 10c to the PCB 7 each of the elements 10a to 10c may be temporarily held in place by a soldering fixture 13 (see FIGS. 2B and 2C). In an embodiment, each of the protrusions 12a to 12n may be configured to make contact with the fixture during a soldering process to hold the structure 10 in place, for example. One the soldering process has been completed, the fixture 13 may be removed from contacting the protrusions 12a to 12n.

In FIG. 2C the end of the grounding section 10a, part of the ground wire 3a and one of the signal conductors 2b have been removed in order to allow the reader to view the conductor 2a and cable 6a.

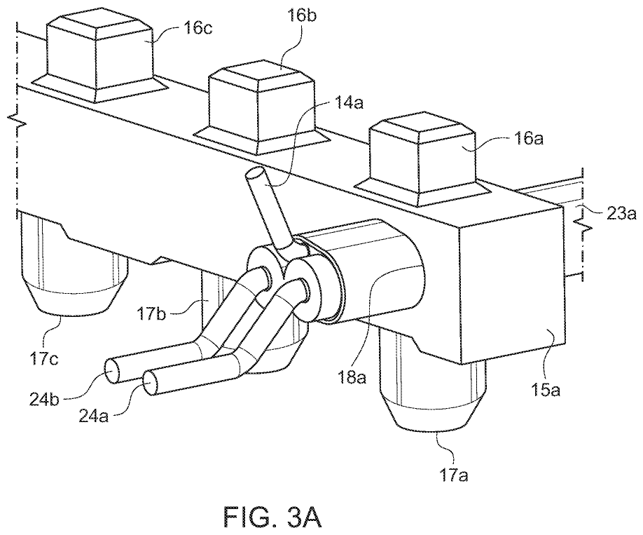

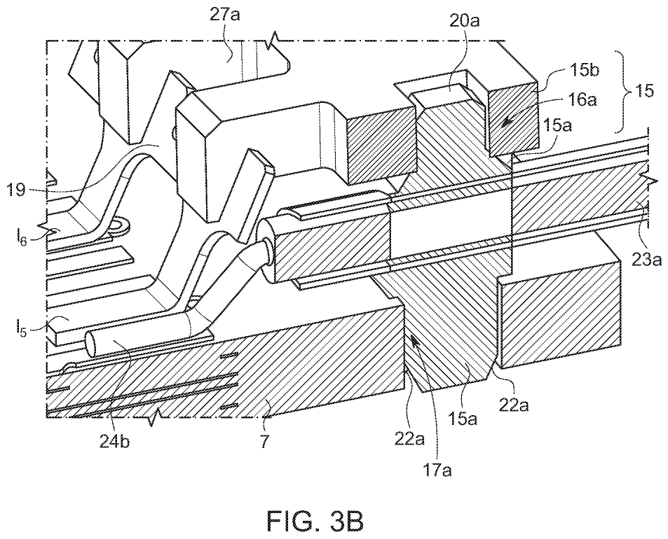

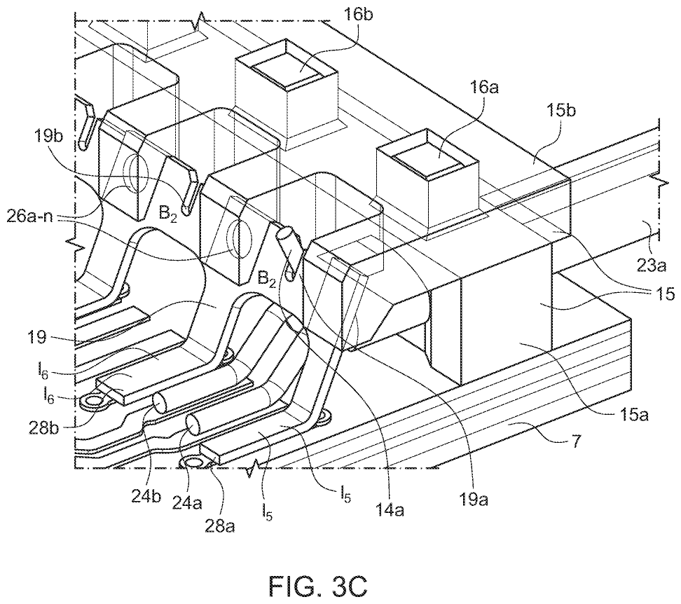

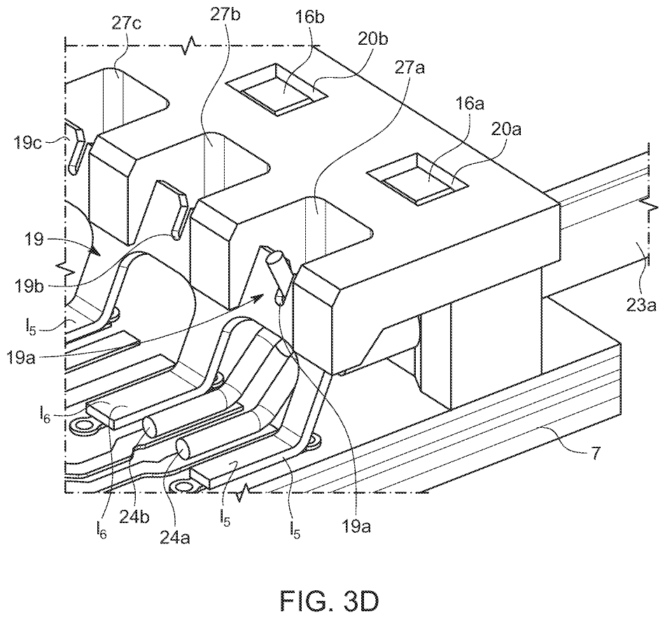

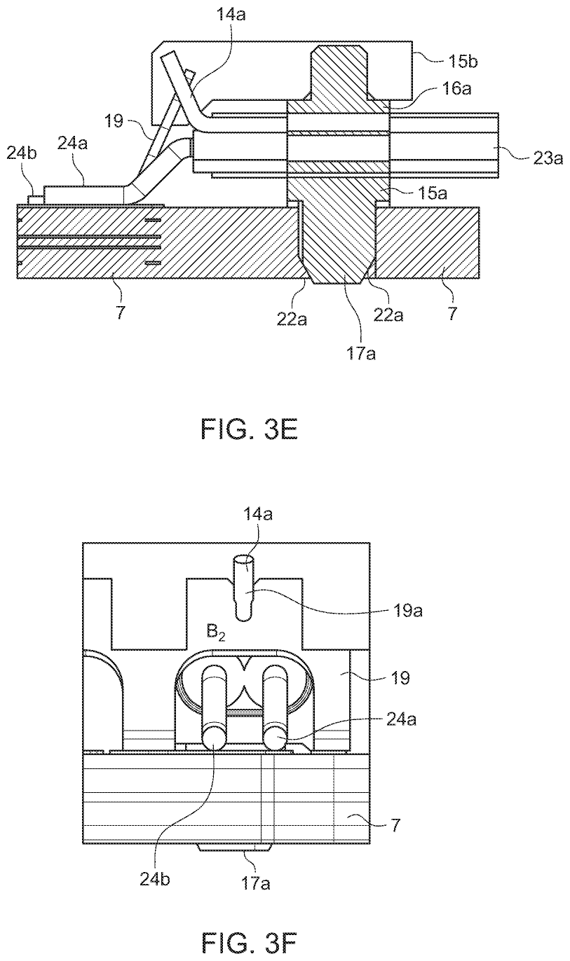

Referring now to FIGS. 3A to 3F there is depicted yet another exemplary embodiment of an inventive connection method and related grounding structure for connecting a ground wire 14a that is part of an inventive cable 23a. In an embodiment, the cable 23a may comprise a twinax cable, for example. As shown, a ground wire 14a of the cable 23a may be configured so that it is connected over the signal conductors 24a, 24b and separated by structures described further below to reduce the chances that the ground wire 14a will make contact with the signal conductors 24a, 24b and cause an electrical short as well substantially eliminating the formation of an unsymmetrical grounding structure.

Cable 23a may comprise one or more core signal conductors 24a, 24n (only two 24a, 24b are shown in FIG. 3A; where “n” indicates a last conductor), insulation and one or more outer layers (e.g., a jacket; not labeled in figures). In the embodiment depicted in FIG. 3A the inventive cable 23a comprises two core signal conductors 24a, 24b (e.g., copper conductors) though it should be understood that this is merely exemplary. Alternatively, the cable 23a may comprise a single core signal conductor or may comprise more than two core conductors. Further, cable 23a may comprise more than one ground wire, it being understood that each ground wire is configured and connected as set forth herein.

Also shown in FIG. 3A is a first part 15a of cable organizer structure 15 that is configured to receive and hold one or more cables 23a to 23n (only one cable 23a is shown for clarity). In one embodiment the first part 15a may be composed of an engineered plastic, such as a Liquid Crystal Polymer (LCP) for example. Further, in an embodiment each cable 23a to 23n may be received into openings 18a to 18n (only one opening 18a is labeled in FIG. 3A).

As depicted in FIG. 3A (and other figures), one exemplary method may comprise receiving and holding at least one cable 23a that comprises at least one signal conductor 24a to 24n and at least one ground wire 14a configured over the at least one signal conductor 24a to 24n in the first part 15a of the cable organizer 15.

As shown in FIG. 3B, the cable organizer structure 15 may comprise at least a first and second part 15a, 15b. For the reader's reference, in FIG. 3B, one of the conductors 24a and the ground wire 14a have been removed to show how both parts 15a, 15b of the cable organizer 15 are connected together and how a first part 15a of the cable organizer 15 is connected to the PCB 7. In alternative embodiments, both sections 15a, 15b of the cable organizer 15 may be combined into one integral component, or further separated into additional sections.

As noted above the first part 15a is configured to receive and hold one or more cables 23a to 23n (only one cable 23a is shown for clarity) that comprises a ground wire 14a configured over conductors 24a, 24n. In an embodiment, the second part 15b may be configured to receive and hold an integral ground bar structure 19 in a substantially fixed position. In an embodiment, each of the first and second parts 15a, 15b of the cable organizer structure 15 may be connected by, for example, inserting an upper interference rib 16a of the first part 15a into an opening 20a of the second part 15b. To further hold the parts 15a, 15b in a fixed position a lower interference rib 17a of the first part 15a may be inserted into an opening 22a of the PCB 7, for example. Because the cable organizer 15 is fixed to the PCB 7 the cable organizer 15 is able to apply restraining forces to the respective cable 23a (and up to cables 23n) and to the integral ground bar 19 in order to hold the cable 23a (and up to cables 23n) and ground bar 19 in a substantially fixed position.

In an embodiment, the second part 15b may also be composed of an engineered plastic, such as an LCP, for example, while the ground bar 19 may be composed of suitably conductive and solderable/weldable material (e.g., a copper alloy) or a plated or conductive laminate material, for example.

Together, the cable 23a (and up to cables 23n), integral ground bar 19, and cable organizer 15 may be a part of a cable assembly 25 that is connected to (or includes) the PCB 7.

Referring now to FIG. 3C there is shown a different view of the cable organizer sections 15a, 15b and ground bar 19. As shown, the second part 15b of the cable organizer structure 15 is depicted transparently to allow the reader to view the passage of cable 23a to the ground bar 19, and openings 26a to 26n in the ground bar 19, for example.

As depicted, the integral ground bar 19 may be configured to comprise one or more open connection slots or notches 19a to 19n (only two 19a, 19b are shown in FIG. 3C), each configured to receive a ground wire (e.g., ground wire 14a) and frictionally restrain the ground wire so that the ground wire 14a is physically in contact with the body “B₂” of the integral ground bar 19, and forms an electrical ground path with the B₂ body as well. The ground path allows unwanted signals to flow to an electrical ground and thereby protect cable 23a (and similarly, up to cables 23n) and minimize the effect of such unwanted signals on desirable signals flowing within conductors 24a, 24b of cable 23a (and similarly, up to cables 23n). Further, because the notches or slots 19a, 19b to 19n restrain the ground wire 14a from moving (only one 14a is shown in FIG. 3C), the inventors believe the configuration described herein may reduce the effects of electrical crosstalk between respective, adjacent cables 23a to 23n (when additional cables are connected).

Though the embodiments in FIGS. 3A to 3F depict the ground bar 19 and notches/slots 19a to 19n as being a part of an integral grounding structure, it should be understood that the ground bar 19 may be divided into separate sections, where each section includes at least one notch/slot, such as notch/slot 19a, for example.

In embodiments the ground wire 14a may be additionally soldered, for example, to the ground bar 19 to name just one of many types of methods that may be used to connect the ground wire 14a to the bar 19. Further, the conductors 24a, 24b may be connected (e.g., soldered) to the PCB 7. Further, supporting structures or legs is l₅ and l₆ of each section 19a to 19n of the ground bar 19 may connect (e.g., via soldering) the ground bar 19 to the PCB 7. In embodiments, each supporting structure or leg l₅ and l₆ of each section 19a to 19n may form a symmetrical ground path, each path including the structure that leads from a termination area (i.e., the position on the section 19a to 19n where the ground wire is connected to the section) to the PCB 7.

Also shown are openings 26a to 26n, where each opening 26a to 26n may be configured to receive material used to securely connect the ground bar 19 to the second part 15b of the cable organizer 15 during an insert molding process, for example.

Further connection points 28a, 28n are shown (only two connection points 28a, 28b are shown). In an embodiment, each connection point 28a 28n may comprise a respective connection, for example, that connects a respective leg l₅, l₆ of the ground bar 19 to the PCB 7, for example. and connection points 28a to 28n. In embodiments, each connection point 28a to 28n may comprise a soldered, welded, laser welded, resistance welded or conductively glue connection, for example.

Referring now to FIG. 3D there is depicted another view of the ground bar 19, and first and second cable organizer sections 15a, 15b. As shown, the second or top cable organizer a section 15b may include a plurality of open access cavities 27a to 27n, each cavity configured to allow access to a respective ground wire 19a to 19n so that a respective ground wire 19a to 19n can be connected (e.g., soldered) to a ground bar 19, for example, and/or to allow repair or visual inspection of a respective ground wire 19a to 19n the ground wire and its connection to the ground bar 19. In an embodiment, the section 15b of the cable organizer may be insert molded, for example.

FIGS. 3E and 3F depict two additional views of the exemplary method and structures to connect one or more ground wires, such as ground wire 14a. In FIG. 3E, a cross sectional view is shown while in FIG. 3F an enlarged view is shown.

While the explanation above and figures herein may depict various inventive methods for connecting inventive cables, it should be understood that the inventive grounding sections and ground bar may be modified to receive additional cable types and their respective ground wire(s) over respective signal conductors. Further, inventive grounding sections and ground bar may be further modified to be connected to a PCB or another devoice, for example.

In more detail, as shown the connective structures (e.g., sections 1a to 1n, 10a to 10n or ground bar 19) may be configured around a termination end of a cable (i.e., where the cable terminates onto a grounding section or to a ground bar) to configure the ground wire over signal conductors and to separate the connected ground wire of the cable from the one or more conductors to prevent short circuits and to reduce unwanted cross-talk, for example.

Continuing, as described previously the sections 1a to 1n, 10a to 10n and ground bar 19 (collectively “connection structures”) may be connected to a PCB using integral and conductive, supporting structures or “legs” l₁ and l₂, l₃ and l₄ and where each of the legs of a respective connection structure may form a symmetrical ground path, each path including the structure that leads from a termination area (i.e., the position on the section or ground bar where the ground wire is connected) to the PCB.

That is to say, while the inventors provide embodiments of connective structures that are connected to a PCB using symmetrical ground paths on one side, and are connected to a ground wire of a cable that terminates at the connective structure on another side, these embodiments are merely exemplary. Other connective structures that comprise symmetrical ground paths may also be utilized, for example.

Said another way, various assemblies that include (i) a PCB, (ii) at least one cable that comprises at least one signal conductor and at least one ground wire configured over the at least one signal conductor, and (iii) a connective structure that is mounted to the PCB and connected to the at least one ground wire that terminates on the connective structure, where the connective structure provides at least two substantially symmetric paths from a termination area to the PCB, are part of the instant disclosure.

While benefits, advantages, and solutions have been described above with regard to specific embodiments of the present invention, it should be understood that such benefits, advantages, and solutions and any element(s) that may cause or result in such benefits, advantages, or solutions, or cause such benefits, advantages, or solutions to become more pronounced are not to be construed as a critical, required, or an essential feature or element of any or all the claims appended to the present disclosure or that result from the present disclosure.

1. A method for connecting a ground wire of cable comprising:
receiving a ground wire of the cable, over one or more core signal conductors of the cable, in an open, connection slot or notch of a respective grounding section of a grounding structure; and
restraining the ground wire so that the ground wire physically contacts a body of the respective grounding section and forms an electrical ground path with the body of the section.

2. The method as in claim 1 where the grounding structure comprises a plurality of integral grounding sections.

3. (canceled)

4. (canceled)

5. (canceled)

6. (canceled)

7. The method as in claim 1 further comprising connecting supporting structures of the grounding section to a PCB 7, where each connection of a supporting structure forms a symmetrical ground path to the PCB.

8. The method as in claim 1 further comprising covering the ground wire and cable with a cable overmold assembly.

9. The method as in claim 8 further comprising affixing the cable overmold assembly to a main housing assembly.

10. The method as in claim 1 further comprising configuring the grounding structure with a plurality of integral grounding sections and a plurality of integral middle sections configured between each grounding section and further configured to contact a top or bottom surface of a PCB.

11. (canceled)

12. The method as in claim 1 further comprising configuring the grounding structure with a plurality of integral grounding sections, each section comprising a protrusion configured to make contact with a fixture during a soldering process to hold the grounding structure in place.

13. (canceled)

14. (canceled)

15. (canceled)

16. (canceled)

17. (canceled)

18. (canceled)

19. (canceled)

20. The method as in claim 1 wherein the ground bar comprises a conductive and solderable/weldable material.

21. (canceled)

22. (canceled)

23. (canceled)

24. (canceled)

25. (canceled)

26. (canceled)

27. An assembly for connecting a ground wire of a cable comprising:
a printed circuit board (PCB);
at least one cable comprising at least one signal conductor and at least one ground wire configured over the at least one signal conductor; and
a connective structure mounted to the PCB and connected to the at least one around wire that terminates on the connective structure at a termination area, where the connective structure provides at least two substantially symmetric paths from the termination area to the PCB.

28. The assembly as in claim 27 wherein the connective structure further comprises at least two legs, each leg forming one of the substantially symmetrical paths.

29. A grounding structure for connecting a ground wire of a cable comprising:
an open slot or notch of a grounding section of the grounding structure that receives a ground wire of the cable configured over one or more core signal conductors of the cable, and restrains the ground wire so that the ground wire physically contacts a body of the grounding section and forms an electrical ground path with the body.

30. The grounding structure as in claim 29 where the grounding structure comprises a plurality of integral grounding sections, each section comprising a respective open, connection slot or notch that receives a respective ground wire of a cable configured over one or more core signal conductors of the respective cable, and each restrains the respective ground wire so that the respective ground wire physically contacts a body of the respective grounding section and forms an electrical ground path with the respective body.

31. The grounding structure as in claim method as in claim 29 wherein the grounding structure comprises a plurality of separate grounding sections, each section comprising a respective open, connection slot or notch that receives a respective ground wire of a cable configured over one or more core signal conductors of the respective cable, and each restrains the respective ground wire so that the respective ground wire physically contacts a body of the respective grounding section and forms an electrical ground path with the respective body.

32. The grounding structure as in claim 29 wherein the cable comprises a twinax cable.

33. (canceled)

34. The grounding structure as in claim 29 further comprising a printed circuit board (PCB) connected to the one or more core signal conductors

35. The grounding structure as in claim 29 wherein the grounding section further comprises supporting structures configured to be connected to a PCB, where each connection of a supporting structure to a PCB forms a symmetrical ground path to the PCB.

36. (canceled)

37. (canceled)

38. The grounding structure as in claim 30, wherein the grounding structure further comprises a plurality of integral middle sections configured between each grounding section and further configured to contact a top surface of a PCB.

39. The grounding structure as in claim 31, wherein the grounding structure further comprises a plurality of integral middle sections configured between each grounding section and further configured to contact a bottom surface of a PCB.

40. The grounding structure as in claim 30, wherein each section comprises a protrusion configured to make contact with a fixture during a soldering process to hold the grounding structure in place.

41. The grounding structure as in claim 29, further comprising a plurality of cables, each cable comprising at least one ground wire configured over one or more core signal conductors of the cable and connected to a respective open slot or notch of a respective grounding section of the grounding structure, the respective open slot or notch restraining the ground wire so that the ground wire physically contacts a body of the respective grounding section and forms an electrical ground path with the body.
